(19) United States
(12) Patent Application Publication
(10) Pub. No.: US 2015/0265921 A1
(43) Pub. Date: Sep. 24, 2015

(54) Game-Aware Compression Algorithms for Efficient Video Uploads

(71) Applicant: Google Inc., Mountain View, CA (US)

(72) Inventors: Duncan John Curtis, Castro Valley, CA (US); Alexander Ruben Stacey McCarthy, San Francisco, CA (US)

(73) Assignee: Google Inc., Mountain View, CA (US)

(21) Appl. No.: 14/221,852

(22) Filed: Mar. 21, 2014

(51) Int. Cl. A63F 13/50

(52) U.S. Cl. CPC A63F 13/50

(57) ABSTRACT

Techniques are provided for creating a game-aware compression algorithm for a specific gaming application. A method may include receiving a gaming application and selecting a video compression technique based on the gaming application. A video codec may be created for the gaming application based on the selected video compression technique. The video codec may be provided to a device on which the gaming application is installed. A compressed video of gameplay within the gaming application may be received from the device, and the video of gameplay may have been compressed using the video codec. Additionally, a method may include receiving, from a gaming application provider, a video codec based on a gaming application. A video of gameplay within the gaming application may be recorded. The recorded video of gameplay may be compressed using the video codec and the compressed video of gameplay may be provided to the gaming application provider.

### BACKGROUND

Typical mobile internet connections are slow with limited bandwidth, and excessive bandwidth consumption is expensive for users. This makes media-rich applications that use mobile devices as a source of video data prohibitively expensive for users. Some modern video compression techniques are designed to minimize the average size of videos with average content. However, these video compression techniques still result in excessively and prohibitively large videos, since these video compression techniques must handle a broad range of content (blurred video, variable lighting conditions, wide range of sounds, etc.). Similarly, audio data also takes up a substantial amount of space in a video. Current audio compression techniques for a video do not rely on external data, such as all sound resources that are included in the application binary.

### BRIEF SUMMARY

According to an embodiment of the disclosed subject matter a method may include receiving a gaming application and selecting one or more video compression techniques based on the gaming application. A video codec may be created for the gaming application based on the one or more selected video compression techniques. Next, the video codec may be provided to a device on which the gaming application is installed. As a result, a compressed video of gameplay within the gaming application may be received from the device, wherein the video of gameplay has been compressed using the video codec for the gaming application.

According to an embodiment of the disclosed subject matter a method may include receiving, from a gaming application provider, a video codec based on a gaming application. A video of gameplay within the gaming application may be recorded. The recorded video of gameplay may be compressed using the video codec and the compressed video of gameplay may be provided to the gaming application provider.

An implementation of the disclosed subject matter provides a system including a processor configured to receive a gaming application and select one or more video compression techniques based on the gaming application. A video codec may be created for the gaming application based on the one or more selected video compression techniques. Next, the video codec may be provided to a device on which the gaming application is installed. As a result, a compressed video of gameplay within the gaming application may be received, from the device, and the video of gameplay may have been compressed using the video codec for the gaming application.

An implementation of the disclosed subject matter provides a system including a processor configured to receive, from a gaming application provider, a video codec based on a gaming application. A video of gameplay within the gaming application may be recorded and the recorded video of gameplay may be compressed using the video codec. The compressed video of gameplay may be provided to the gaming application provider.

According to an embodiment of the disclosed subject matter a method may include means for receiving a gaming application and means for selecting one or more video compression techniques based on the gaming application. The method may include means for creating a video codec for the gaming application based on the one or more selected video compression techniques. Next, the method may include means for providing the video codec to a device on which the gaming application is installed. As a result, the method may include means for receiving a compressed video of gameplay within the gaming application from the device, wherein the video of gameplay has been compressed using the video codec for the gaming application.

According to an embodiment of the disclosed subject matter a system may include means for receiving, from a gaming application provider, a video codec based on a gaming application. The system may include means for recording a video of gameplay within the gaming application. The system may also include means for compressing the recorded video of gameplay using the video codec and means for providing the compressed video of gameplay to the gaming application provider.

Techniques are provided for creating a game-aware compression algorithm for efficient video uploads. By creating a video codec specific to a particular gaming application, the system may be able to more efficiently compress a user's gameplay video in the gaming application. Accordingly, the techniques disclosed herein may result in faster transfer speeds while minimizing bandwidth requirements and costs for users. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example process according to an implementation of the disclosed subject matter.

FIG. 2 shows an example process according to an implementation of the disclosed subject matter.

FIG. 3 shows an example information flow according to an implementation of the disclosed subject matter.

FIG. 4 shows a computer according to an embodiment of the disclosed subject matter.

FIG. 5 shows a network configuration according to an embodiment of the disclosed subject matter.

### DETAILED DESCRIPTION

Given the popularity of gaming applications and social gaming, it has become increasingly popular for users of a gaming application to record a video of gameplay within an application and share the video with other users. Taking a gaming application as an example, a user of a gaming application may capture a video on a mobile device of the user's gameplay in a gaming application. Other users of the same gaming application may also capture videos of their gameplay in the gaming application on their mobile devices. When each of the users who have captured a gameplay video in a gaming application wish to upload their gameplay video to a video sharing site, issues can arise with upload speed and the cost of the upload can be relatively high. One problem is that these videos can be several minutes long and as a result may be uploaded slowly while maximizing bandwidth requirements and costs for users.

The present disclosure provides a method for creating a video codec for videos of gameplay associated with a particular gaming application. For example, for a particular gaming application, a gaming application provider may create a custom video codec. This video codec may statistically model the likely content of a video of a user's gameplay in the gaming application, and the expected deviations from that norm. For example, first-person shooting games typically have a large, dark gun in the center of the screen that may move back and forth, whereas puzzle games typically have small, regularly shaped objects in bright, primary colors that move in regular patterns. A custom video codec may be provided to devices on which a particular gaming application is installed. Following recording a video of gameplay within the gaming application on a device, the custom video codec may be used to compress the video of gameplay. By creating a video codec specific to a particular gaming application, the system may be able to more efficiently compress a user's gameplay video in the gaming application. This may allow for a faster transfer of the compressed video of gameplay when a user wishes to upload his video to a video sharing site or share his video, for example, with another user.

The system may regularly evaluate uploaded user gameplay videos associated with a specific gaming application and periodically (e.g. nightly, weekly, and/or monthly, based on the popularity of the gaming application) perform a server pass of a video sharing site and all videos associated with the gaming application uploaded by users. As a result, when a user turns on a video capture mode in the gaming application, the gaming application software development kit (SDK) may automatically check to see if an updated game-specific video codec is available, and if it is, the newest video codec for the gaming application may be downloaded. This may allow for hyper compression of any locally recorded gameplay video that can be uploaded to a server. Once uploaded, the gameplay video may be decompressed and then compressed into a standard format and sent to a video sharing site, at a fast speed. The video compression techniques described herein for creating a custom video codec may bias towards repetitive content and content found in the gaming application binary resources.

In some cases, a large amount of video data may not be available for a specific gaming application (e.g., a new gaming application for which there may not be many previously uploaded gameplay videos available) and may make it difficult to create a custom video codec for the gaming application. In this case, the system may analyze the contents of the application binary interface and may extract all pre-made images used in the gaming application. As a specific example, for 2D games, the system may extract draw commands from the application programming interface (API) instead of capturing the screen output. These draw instructions may also form another source of data to enhance the amount of compression achievable in a video codec, or to replace direct video recording entirely. For example a draw commands such as “draw texture 7394 at screen coordinate 20, 20” would be more compressible than standard video frames.

Similarly, audio can be compressed by reversing the approach used by a music tracker and/or sequencer. By evaluating an API, the system may identify when a gaming application triggers a music or audio file to be played. Rather than recording and compressing the final audio stream, the system may record these audio playback events (e.g. “play(levelWinSound)”) and the sound may be re-processed on the server using the audio clips available in the gaming application's uploaded binary. For most gaming applications, the system may require just a few bytes or kilobytes to compress minutes or hours of game audio.

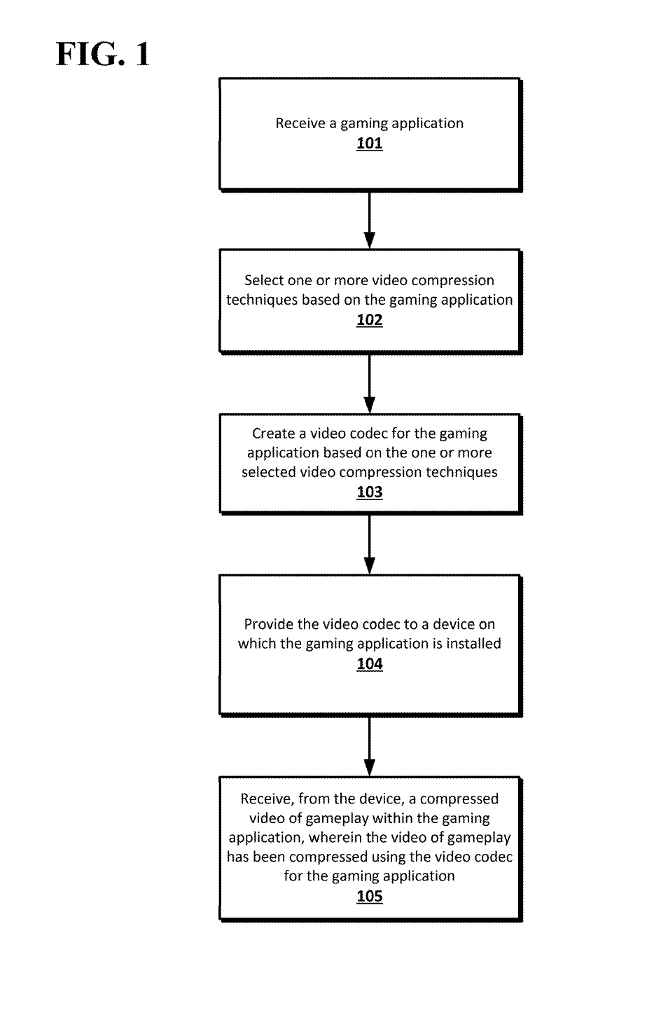

In general, methods and systems are provided for creating a video codec for a particular gaming application and compressing a video of gameplay recorded within the gaming application using the video codec. FIG. 1 shows an example process according to an implementation of the disclosed subject matter. As shown, a method may include receiving a gaming application, at 101. In general, a gaming application may be any application that may be run and/or installed on a device, and within which a user may play a game. A gaming application may be an application within which a user may be able to record a video of gameplay. A video of gameplay may be a recording of a user's interaction within a gaming application. In general, gameplay in a gaming application may be the pattern defined through the game rules, the connection between player and the game, challenges and overcoming challenges, plot, and/or a player's connection with the plot. A device on which a gaming application may be run and/or installed may be a mobile device, a set-top box, a smartphone, a tablet, a laptop, a PC, a wearable computer, a gaming console, and the like. A gaming application may include various instructions and/or files such as a draw call command, an image, text, a video clip, a graphic, an audio clip, and the like.

At 102, one or more video compression techniques based on the gaming application may be selected. In general, any video compression technique may be selected based on the gaming application. In some cases, the number of previously received (e.g., previously uploaded to a gaming application provider and/or shared on a video sharing site) videos of gameplay recorded within a gaming application may be used to select one or more video compression techniques for creating a video codec for the gaming application. Other factors may be considered in selecting a video compression technique, such as the type of gaming application (e.g., puzzles, action, word games, etc.), the number of instructions and/or files included in a gaming application, the complexity of images and/or graphics displayed in a gaming application, and the like. For example, a particular video compression technique may be more suitable for a gaming application that includes complex images and/or graphics.

Based on the selected video compression technique, a video codec may be created for the gaming application, at 103. Examples of video compression techniques that may be selected and used to create a video codec include a statistical analysis, an application asset analysis, and any other suitable technique for creating a video codec. A video codec may be created for a gaming application based on one or a combination of multiple video compression techniques. In some cases, for example, if a large corpus of videos of gameplay have been previously recorded within the same gaming application, a statistical analysis compression technique may be used to create a video codec for compressing videos of gameplay for the gaming application. In addition, an application asset analysis compression technique may be used in combination with the statistical analysis to create the video codec. In other cases, if no videos of gameplay (or very few) have been recorded within a gaming application (e.g., a newly released gaming application), an application asset analysis compression technique may be used to create a video codec for the gaming application, which may be used to compress videos of gameplay that may be recorded within the gaming application in the future. Following creation of a video codec at 103, the video codec may be provided, e.g., by a gaming application provider, to a device on which the gaming application has been installed, at 104. As a result, a compressed video of gameplay within the gaming application, that has been compressed using the video codec, may be received, e.g., by a gaming application provider, at 105. Additionally, the compressed video of gameplay, received from the device, may be decompressed using the video codec for the gaming application. Decompression of a video of gameplay may be performed by the same or different entity which created the video codec. For example, a gaming application provider may create a video codec for a gaming application as described herein and provide the video codec to the device on which the gaming application is installed and to a video sharing site. The video sharing site may decompress a compressed video of gameplay, received from a device, using the same video codec for the gaming application.

As mentioned above, one or more video compression techniques may be selected and used to create a video codec for a gaming application. One such video compression technique is a statistical analysis. A statistical analysis compression technique may be based on a corpus of videos of gameplay recorded within the same gaming application. Based on a statistical analysis of these videos of gameplay, particular qualities of average images and average videos may be identified. According to an implementation, a statistical analysis may include identifying one or more frequently occurring video content frames from a plurality of previously received videos of gameplay within the gaming application. In addition, the statistical analysis may also include computing one or more expected average video frames based on one or more frequently occurring video content frames. As a result, a compressed video of gameplay, that has been compressed using the video codec, may include a difference between a video frame in the recorded video of gameplay and an expected average video frame based on multiple videos of gameplay that have been previously recorded within the gaming application. For example, multiple frames in the gaming application Furious Ferrets may include a pause button in the top left corner of the screen. In this case, a portion of images and/or video content frames within multiple videos of gameplay may be identified that are often the same or similar, and frequently occurring, in the majority of the videos of gameplay. Accordingly, an expected average frame may be computed and the difference between an actual frame and the expected average frame may be stored. As a result, during compression of a video of gameplay using a video codec created using a statistical analysis, only the difference between the video content frames in the video being compressed and the expected average frames may be stored. As in the Furious Ferrets example, if the standard deviation of particular video content frames is low, these predictions based on statistical analysis will be very accurate. For example, compression of a video of gameplay within the Furious Ferrets gaming application using a video codec created using this statistical analysis may only require a small number of bytes to encode the upper left pause button. This is because the created video codec includes examples of expected average video frames that already include the identical pause button. For videos of gameplay within gaming applications that are relatively predictable, compression of a video of gameplay using a video codec created according to the statistical analysis technique will be nearly optimal. For example, in a particular gaming application it may be the case that after starting a certain level in the game, the game does not require the user to interact with the game for a few seconds. Accordingly, the first few seconds of the level in a video of gameplay and the corresponding first few video content frames should be nearly identical for all or most of the recorded videos of gameplay. As a result, this statistical analysis may be used to create a video codec that results in nearly optimal compression of the corresponding video content frames in recorded videos of gameplay.

For example, a gaming application called Sugar Smash may be a strategy game involving the arrangement of sugar pieces in a grid. Sugar Smash may have become very popular among users and approximately 1,000 users may have uploaded a video of gameplay recorded within Sugar Smash. In this case, because, for example, 90% of the video frame content in each of the 1,000 videos of gameplay may display a grid of sugar pieces, a statistical analysis technique may be used to create a video codec. Based on the statistical analysis, the video codec may include one or more expected average video frames. As an example, an expected average video frame Sugar Smash may include a yellow sugar piece in the top left corner of the grid and a blue sugar piece right next to the yellow sugar piece. During compression of a video of gameplay recorded within Sugar Smash, differences between an actual frame in the video and the expected average frame may be stored. For example, an actual frame in the video may include a yellow sugar piece in the top left corner of the grid and a red sugar piece (rather than a blue sugar piece as in the expected average frame) right next to the yellow sugar piece. Accordingly, the compressed video of gameplay may include differences between actual frames in the video of gameplay and the expected average frames (e.g., the red sugar piece as opposed to the blue sugar piece next to the yellow sugar piece) rather than storing the entire video content frame of the grid, the yellow sugar piece, and the second sugar piece.

Another video compression technique is an application asset analysis. An application asset analysis of the gaming application may be used to create a video codec before and/or after one or more videos of gameplay have been recorded (i.e., an application asset analysis may be a post-recording video compression technique and/or a pre-recording video compression technique). An application asset analysis may be based on the application package file (e.g., any file format used to encode an application) associated with a gaming application, which is typically distributed to users by a gaming application provider. According to an implementation, the application asset analysis may include extracting, from the gaming application (e.g., from the application package file), one or more image assets. Based on the application asset analysis, an application package file for a gaming application may be analyzed to identify binary image assets included in the gaming application. For example, a pause button in the gaming application Furious Ferrets may be included in the application package file as a pre-rendered image file, such as a portable network graphic (PNG) file. One or more of these image assets, e.g., pre-packaged image files, may be identified in the application package file for a gaming application. As a result, these image assets may be used to build a video codec that is a predictive compression algorithm.

According to an implementation, a video codec may be created for a gaming application by storing an image asset in a remote storage location. In this case, a video of gameplay that has been compressed using the video codec may include a reference to the remote storage location storing the image asset that appears in the video rather than storing the image itself. As a result, upon decompressing a video of gameplay that was compressed using the video codec, the reference to the remote storage location may be used to retrieve the stored image asset. Similar to the statistical analysis technique described above, the application asset analysis may be more efficient when frames in a video of gameplay are primarily composed from content that matches the predictions of image assets according to the video codec. The compression of a video of gameplay using a video codec that was created using an application asset analysis video compression technique would be much faster than traditional compression techniques. For example, a traditional non-game-aware compression algorithm would have to compress the pause button in the Furious Ferrets gaming application, as in the example above, as arbitrary content. Accordingly, a traditional compression algorithm may require hundreds of bytes to represent the color, shape, outline, etc. of the pause button. However, according to the present disclosure, the asset analysis compression technique may recognize that the pause button matches the image asset that is already stored in the application package file for Furious Ferrets, and a reference to that image asset may be stored rather than the image itself. Typically, since the number of assets in an application package file may be limited, storage of assets and/or references to assets may be more efficient by sorting the assets in order of the frequency of their use, giving each asset a number corresponding to their use frequency (e.g., 1=most common, 2=second most common, etc.), and then using a variable-length encoding scheme to send the image reference numbers during decompression. In this case, compression of the pause button may require a few bits to reference the common pause image that may appear in all or most of the videos of gameplay recorded within the gaming application. Although the example provided above describes identifying and storing image assets in an application package file, the application asset analysis compression technique may also be used to identify and store other assets in an application package file such as an audio clip asset, a video clip asset, and the like.

According to an implementation, the application asset analysis may include extracting, from the gaming application, one or more draw call commands. According to an implementation, creating a video codec for the gaming application may include storing a draw call command in a remote storage location. In this case, a video of gameplay that has been compressed using the video codec may include a reference to the remote storage location storing the draw call command. As a result, upon decompressing a video of gameplay that was compressed using the video codec, the reference to the remote storage location may be used to retrieve and recreate the stored draw call command. Taking 2D gaming applications as an example, an application asset analysis technique may include recording draw commands from the graphics processing unit (GPU) or the API, instead of capturing the screen output as is done by some traditional compression algorithms. As an example, for a 2D gaming application, an asset-based video codec may be created and/or optimized by modifying the system calls made by a gaming application to draw and/or display graphics on the screen of a device. For example, in the Furious Ferrets gaming application discussed above, the pause button may be drawn on the screen of a device by making an API draw call such as “(screen.drawImage(PAUSE_IMAGE, topLeftPosition, bottomRightPosition).” This call may pass the image information to a graphics card for rendering on the screen of the device. In this case, this draw call may be recorded to a log that may be used later to replay the draw calls in the same order they were made by the gaming application, for example during decompression of a video that was compressed using the video codec. As a result, rather than analyzing the pixels that are drawn on the screen, as is done by traditional compression techniques, an application asset analysis technique as disclosed herein may use logged draw call information to recreate the rendering of an image asset during decompression. As an example, a single frame of an uncompressed video of gameplay on a high resolution tablet could be 1920×1200 pixels×32 color bits per pixel, which is more than 8 MB per frame uncompressed. However, according to the techniques disclosed herein, storing multiple, e.g., a few hundred, uncompressed draw calls would only require a few kilobytes. Additionally, the draw call data is highly compressible since the numbers and arguments will be highly repetitive in all videos of gameplay recorded within the same particular gaming application, and thus can be compressed losslessly to ensure perfect image quality following compressing and/or decompressing a video of gameplay.

For most gaming applications available from a gaming application provider, there may be a binary version of each gaming application. This binary version of a gaming application may include all or most of the common images in the gaming application. Based on the application asset analysis technique, a video codec may be created for the gaming application using the common images from the binary version. For example, during compression of a video of gameplay within a gaming application, a common image may be identified in the video and replaced with the image from the application binary (i.e., smaller file size than the image in the video). For example, a video of gameplay within a gaming application Veggie Fighter may include an image of a carrot that is 50 pixels×50 pixels (total 2500 pixels). During compression of the video using the video codec created for Veggie Fighter, rather than store the image of the carrot as a color 2500 pixel image, the image of the carrot from the binary version of Veggie Fighter may be stored instead, which would require much less storage space than the color 2500 pixel carrot image. As another example, a gaming application may begin by displaying a text box including text such as “Hello Fred” that is written on the screen of the device. In particular, the application package file for the gaming application may include a draw call instruction such as “at pixel 29 draw a string and write “Hello Fred”), in addition, this draw call instruction may include multiple parameters associated with the text box such as the text to display, pixels, color, brightness, shape, orientation, etc. A video of gameplay recorded within the gaming application may include a video content frame that includes an image of the text box displaying “Hello Fred.” When compressing this video of gameplay using the video codec, the draw call instruction that indicated what to draw and the associated parameters may be stored rather than evaluating the video to identify and store the image of the text box.

Following creation of a video codec for a gaming application, the video codec may be updated based on multiple previously received videos of gameplay within the gaming application. For example, as the system continuously receives compressed videos of gameplay within the gaming application over time, the video compression techniques described herein may be used to update the video codec. According to an implementation, an updated video codec may be provided to a device on which the gaming application is installed. As a result, the speed and accuracy of compression of videos of gameplay in a gaming application may continuously improve as the video codec is continuously updated based on new videos received by the system.

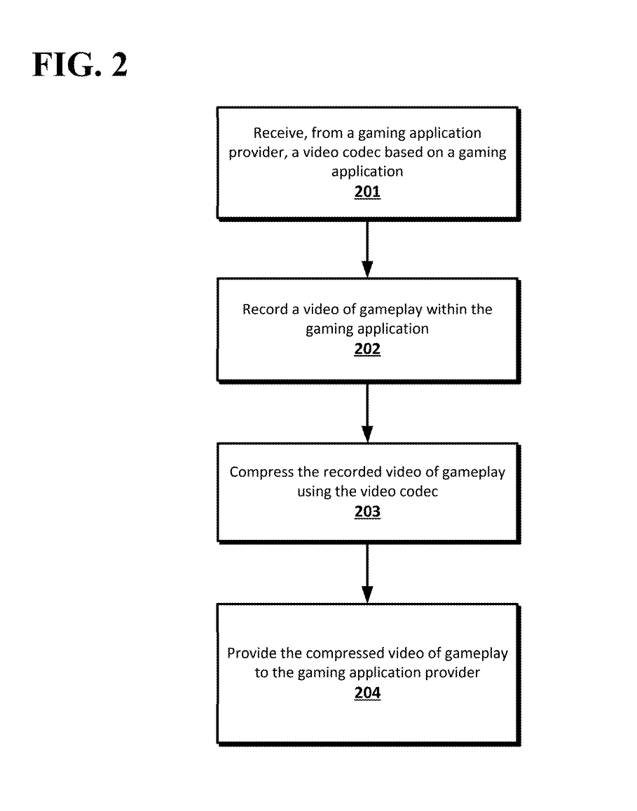

According to an implementation, a video of gameplay recorded within the gaming application may be compressed using the video codec created according to the techniques described herein. FIG. 2 shows an example process according to an implementation of the disclosed subject matter. As shown, a method may include receiving, from a gaming application provider, a video codec based on a gaming application, at 201. The video codec may have been created according to the techniques described herein and as shown in FIG. 1. In general, the gaming application may be received at the device, from the gaming application provider, prior to receiving the video codec based on the gaming application. A video of gameplay may be recorded within the gaming application, at 202. For example, a video of gameplay may be recorded within the gaming application in response to a request received from a user of the device while playing the gaming application. In some cases, a request to record the video of gameplay within a gaming application may be received prior to the step of receiving, from a gaming application provider, a video codec based on the gaming application. For example, a video codec may not be received from a gaming application provider until after the user has requested to transfer the video of gameplay from the device. The recorded video of gameplay may be compressed using the video codec, at 203, and the compressed video of gameplay may be provided to the gaming application provider, at 204.

A compressed video of gameplay recorded within a gaming application may be compressed, at the device, using a video codec that was created for the gaming application. According to the video compression techniques described herein, a compressed video of gameplay recorded within the gaming application and compressed using the video codec created for the gaming application may include a reference to a remote storage location storing an image asset and/or a reference to a remote storage location storing a draw call command. Further, compressing the recorded video of gameplay using the video codec may include storing a difference between a video frame in the recorded video of gameplay and an expected average video frame based on multiple videos of gameplay that were previously recorded within the gaming application.

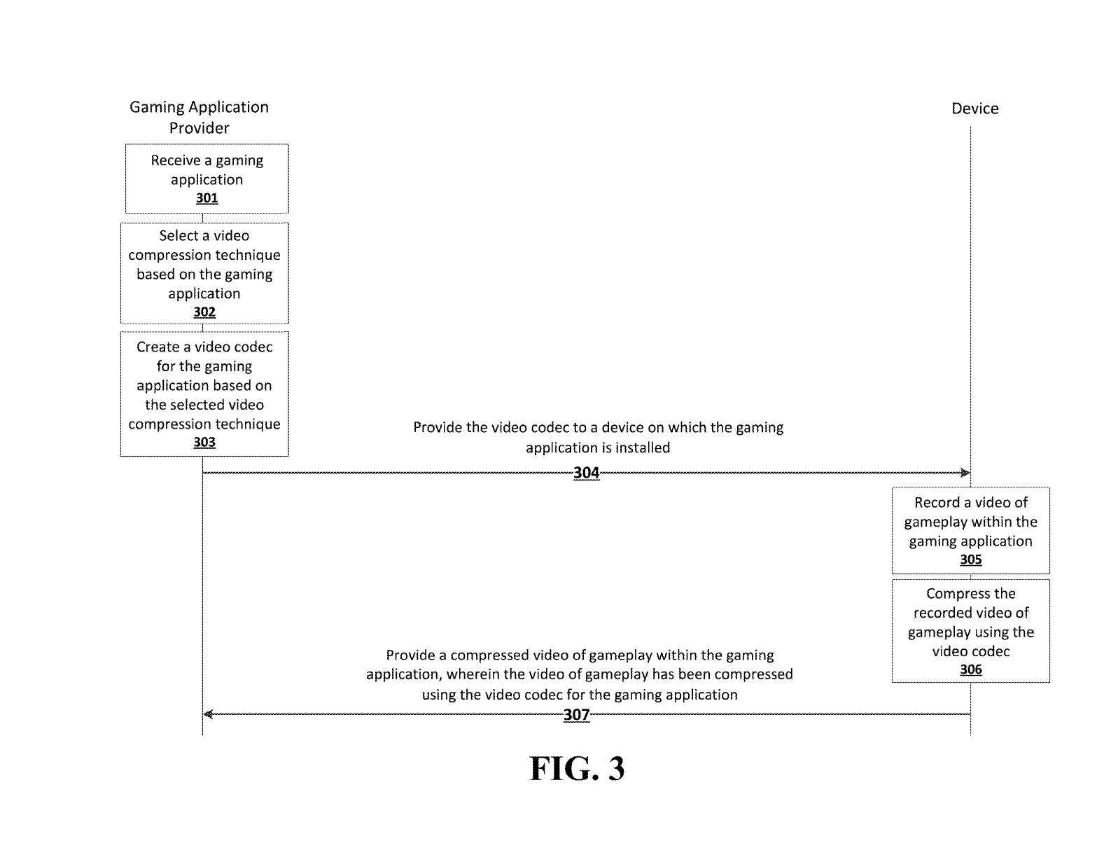

As described herein, methods and systems are provided for creating a video codec for a particular gaming application and compressing a video of gameplay recorded within the gaming application using the video codec. FIG. 3 shows an example information flow according to an implementation of the disclosed subject matter. As shown, a gaming application provider may receive a gaming application, e.g., from a developer of the gaming application, at 301. At 302, the gaming application provider may select one or more video compression techniques, such as the statistical analysis and/or application asset analysis techniques described above, based on the gaming application. As discussed above, various factors may be considered by a gaming application provider in selecting a video compression technique. Based on the selected video compression technique(s), the gaming application provider may create a custom video codec specifically for the gaming application, at 303. The video codec may be created according to the techniques described herein. Next, the gaming application provider may provide the video codec to a device on which the gaming application is installed, at 304. The device may record a video of gameplay within the gaming application, at 305. Although not shown in FIG. 3, the device may record a video of gameplay within the gaming application prior to receiving the video codec from the gaming application provider, i.e., step 305 may occur before step 304. For example, a device may receive the video codec from the gaming application provider after a user of the device has requested to transfer a video of gameplay recorded in the gaming application to another location. In another case, the video codec may be an updated video codec that may be received, at a device, from the gaming application provider before or after a video of gameplay has been recorded within the gaming application. The device may compress the recorded video of gameplay using the video codec received from the gaming application provider, at 306. Next, the device may provide the compressed video of gameplay that has been compressed using the video codec to the gaming application provider, at 307. Alternatively or in addition, the device may provide the compressed video of gameplay to another location such as another device, a video sharing site, a website, a social network, and the like. In some cases, the gaming application provider may be the same entity as a video sharing site, a website, a social network, etc.

In an implementation, communication between a gaming application provider and a device may be across one or more bridges between the interfaces. For example, the communications between the gaming application provider and a device may be managed or assisted by a third device, such as, a coordinating device, a local coordinator, a remote server, etc. In such cases, the third device may, for example, receive a gaming application, select a video compression technique based on the gaming application, and/or create a video codec for the gaming application based on the selected video compression technique. The third device may then provide the video codec to a device on which the gaming application is installed. In some cases, the third device may provide the video codec to the gaming application provider, in which case, the gaming application provider may receive a compressed video of gameplay within the gaming application from a device. Alternatively, the third device may receive a compressed video of gameplay and provide the compressed video of gameplay to the gaming application provider. Furthermore, more than one intermediate device may be implemented to facilitate communication between a gaming application provider and one or more devices.

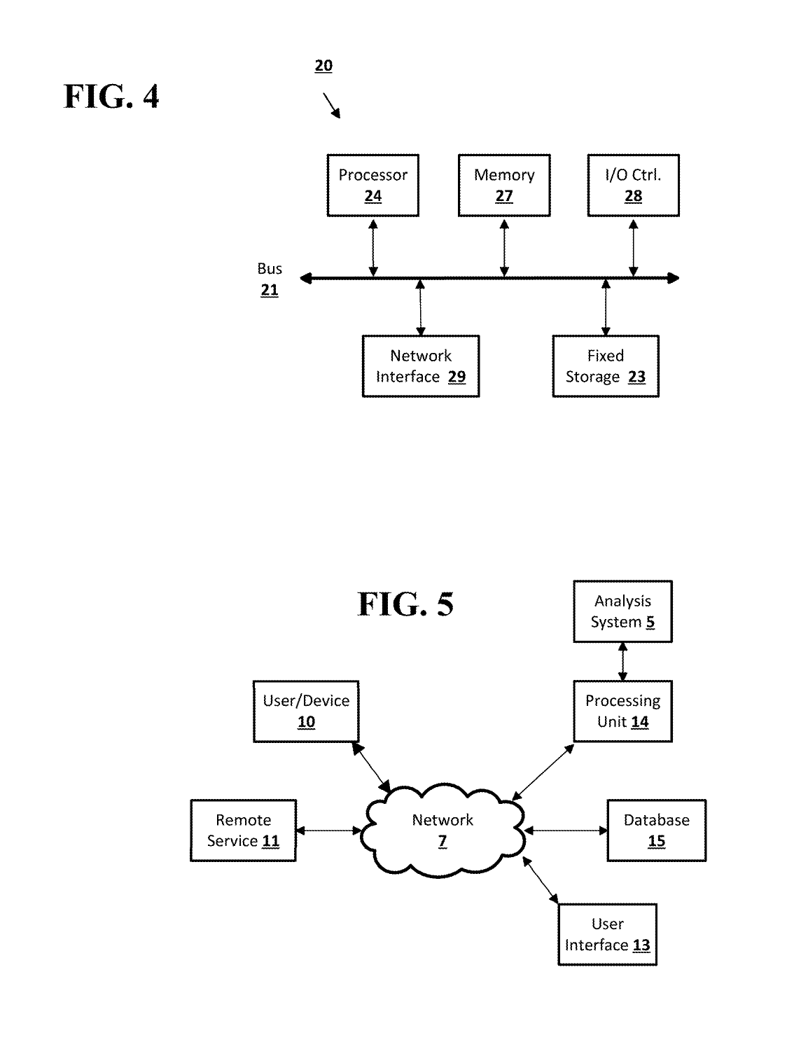

Embodiments of the presently disclosed subject matter may be implemented in and used with a variety of component and network architectures. FIG. 4 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 5.

Many other devices or components (not shown) may be connected in a similar manner, such as document scanners, digital cameras, auxiliary, supplemental, or backup systems, or the like. Conversely, all of the components shown in FIG. 4 need not be present to practice the present disclosure. The components can be interconnected in different ways from that shown. The operation of a computer such as that shown in FIG. 4 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 5 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as CD-ROMs, DVDs, hard drives, USB (universal serial bus) drives, flash drives, or any other non-transitory machine readable storage medium, such that when the computer program code is loaded into and executed by a computer, the computer becomes an apparatus for practicing embodiments of the disclosed subject matter. Embodiments also may be embodied in the form of computer program code, for example, whether stored in a non-transitory storage medium, loaded into and/or executed by a computer. When the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information, as previously described. The memory or other storage medium may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
receiving a gaming application;
selecting one or more video compression techniques based on the gaming application;
creating a video codec for the gaming application based on the one or more selected video compression techniques;
providing the video codec to a device on which the gaming application is installed; and
receiving, from the device, a compressed video of gameplay within the gaming application, wherein the video of gameplay has been compressed using the video codec for the gaming application.

2. The method of claim 1, wherein the one or more video compression techniques is selected based on the number of previously received videos of gameplay within the gaming application.

3. The method of claim 1, wherein the one or more video compression techniques comprises at least one of: a statistical analysis and an application asset analysis.

4. The method of claim 1, wherein the one or more video compression techniques comprises an application asset analysis of the gaming application.

5. The method of claim 4, wherein the application asset analysis comprises extracting, from the gaming application, at least one of: one or more image assets and one or more draw call commands.

6. The method of claim 5, wherein creating a video codec for the gaming application comprises storing a first image asset in a remote storage location; and wherein the received compressed video of gameplay comprises a reference to the remote storage location storing the first image asset.

7. The method of claim 5, wherein creating a video codec for the gaming application comprises storing a first draw call command in a remote storage location; and wherein the received compressed video of gameplay comprises a reference to the remote storage location storing the first draw call command.

8. The method of claim 1, wherein the one or more video compression techniques comprises a statistical analysis of the gaming application.

9. The method of claim 8, wherein the statistical analysis comprises identifying one or more frequently occurring video content frames from a plurality of previously received videos of gameplay within the gaming application.

10. The method of claim 9, wherein the statistical analysis further comprises computing one or more expected average video frames based on the one or more frequently occurring video content frames.

11. The method of claim 1, wherein the compressed video of gameplay comprises a difference between a video frame in the recorded video of gameplay and an expected average video frame based on a plurality of videos of gameplay within the gaming application.

12. The method of claim 1, further comprising updating the video codec based on a plurality of previously received videos of gameplay within the gaming application.

13. The method of claim 12, further comprising providing the updated video codec to the device on which the gaming application is installed.

14. The method of claim 1, further comprising decompressing the compressed video of gameplay, received from the device, using the video codec for the gaming application.

15. A method comprising:
receiving, from a gaming application provider, a video codec based on a gaming application;
recording a video of gameplay within the gaming application;
compressing the recorded video of gameplay using the video codec; and
providing the compressed video of gameplay to the gaming application provider.

16. The method of claim 15, further comprising receiving a request to record the video of gameplay within a gaming application prior to the step of receiving, from a gaming application provider, a video codec based on the gaming application.

17. The method of claim 15, further comprising receiving, at a device, the gaming application from the gaming application provider prior to receiving, from the gaming application provider, the video codec based on the gaming application.

18. The method of claim 15, wherein the compressed video of gameplay comprises a reference to a remote storage location storing a first image asset.

19. The method of claim 15, wherein the compressed video of gameplay comprises a reference to a remote storage location storing a first draw call command.

20. The method of claim 15, wherein compressing the recorded video of gameplay using the video codec comprises storing a difference between a video frame in the recorded video of gameplay and an expected average video frame based on a plurality of videos of gameplay within the gaming application.

21. A system comprising:
a processor configured to:
receive a gaming application;
select one or more video compression techniques based on the gaming application;
create a video codec for the gaming application based on the one or more selected video compression techniques;
provide the video codec to a device on which the gaming application is installed; and
receive, from the device, a compressed video of gameplay within the gaming application, wherein the video of gameplay has been compressed using the video codec for the gaming application.

22. The system of claim 21, wherein the one or more video compression techniques is selected based on the number of previously received videos of gameplay within the gaming application.

23. The system of claim 21, wherein the one or more video compression techniques comprises at least one of: a statistical analysis and an application asset analysis.

24. The system of claim 21, wherein the one or more video compression techniques comprises an application asset analysis of the gaming application.

25. The system of claim 24, wherein the application asset analysis comprises extracting, from the gaming application, at least one of: one or more image assets and one or more draw call commands.

26. The system of claim 25, wherein creating a video codec for the gaming application comprises storing a first image asset in a remote storage location; and wherein the received compressed video of gameplay comprises a reference to the remote storage location storing the first image asset.

27. The system of claim 25, wherein creating a video codec for the gaming application comprises storing a first draw call command in a remote storage location; and wherein the received compressed video of gameplay comprises a reference to the remote storage location storing the first draw call command.

28. The system of claim 21, wherein the one or more video compression techniques comprises a statistical analysis of the gaming application.

29. The system of claim 28, wherein the statistical analysis comprises identifying one or more frequently occurring video content frames from a plurality of previously received videos of gameplay within the gaming application.

30. The system of claim 29, wherein the statistical analysis further comprises computing one or more expected average video frames based on the one or more frequently occurring video content frames.

31. The system of claim 21, wherein the compressed video of gameplay comprises a difference between a video frame in the recorded video of gameplay and an expected average video frame based on a plurality of videos of gameplay within the gaming application.

32. The system of claim 21, wherein the processor is further configured to update the video codec based on a plurality of previously received videos of gameplay within the gaming application.

33. The system of claim 32, wherein the processor is further configured to provide the updated video codec to the device on which the gaming application is installed.

34. The system of claim 21, wherein the processor is further configured to decompress the compressed video of gameplay, received from the device, using the video codec for the gaming application.

35. A system comprising:
a processor configured to:
receive, from a gaming application provider, a video codec based on a gaming application;
record a video of gameplay within the gaming application;
compress the recorded video of gameplay using the video codec; and
provide the compressed video of gameplay to the gaming application provider.

36. The system of claim 35, wherein the processor is further configured to receive a request to record the video of gameplay within a gaming application prior to the step of receiving, from a gaming application provider, a video codec based on the gaming application.

37. The system of claim 35, wherein the processor is further configured to receive, at a device, the gaming application from the gaming application provider prior to receiving, from the gaming application provider, the video codec based on the gaming application.

38. The system of claim 35, wherein the compressed video of gameplay comprises a reference to a remote storage location storing a first image asset.

39. The system of claim 35, wherein the compressed video of gameplay comprises a reference to a remote storage location storing a first draw call command.

40. The system of claim 35, wherein compressing the recorded video of gameplay using the video codec comprises storing a difference between a video frame in the recorded video of gameplay and an expected average video frame based on a plurality of videos of gameplay within the gaming application.
